(19) United States
(12) Patent Application Publication
(10) Pub. No.: US 2005/0113246 A1
(43) Pub. Date: May 26, 2005

(54) Process of producing an organic catalyst

(75) Inventors: George Douglas Hiler II, Harrison, OH (US); Gregory Scot Miracle, Hamilton, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/978,945

(22) Filed: Nov. 1, 2004

Related U.S. Application Data
(60) Provisional application No. 60/517,947, filed on Nov. 6, 2003.
(60) Provisional application No. 60/519,443, filed on Nov. 12, 2003.
(60) Provisional application No. 60/531,100, filed on Dec. 19, 2003.

(51) Int. Cl. B01J 31/00

(52) U.S. Cl. 502/167; 502/168

(57) ABSTRACT

This invention relates to a process of producing organic catalysts that may comprise iminium or oxaziridinium moieties, cleaning compositions comprising such catalysts; and methods of using such catalysts and cleaning products containing such catalysts.

### CROSS-REFERENCES TO RELATED APPLICATIONS

This application claims priority under 35 U.S.C. § 119(e) to U.S. Provisional Application Ser. No. 60/517,947 filed Nov. 6, 2003, U.S. Provisional Application Ser. No. 60/519,443 filed Nov. 12, 2003, and U.S. Provisional Application Ser. No. 60/531,100 filed Dec. 19, 2003.

### FIELD OF INVENTION

This invention relates to processes for producing molecules useful as organic catalysts, organic catalysts, cleaning compositions comprising such catalysts, and methods of using such catalysts and cleaning products.

### BACKGROUND OF THE INVENTION

Oxygen bleaching agents, for example hydrogen peroxide, are typically used to bleach fibers and various surfaces. Unfortunately such agents are extremely temperature rate dependent. As a result, when such agents are employed in colder solutions, the bleaching action of such solutions is markedly decreased.

In an effort to resolve the aforementioned performance problem, certain organic catalysts have been developed. As the processes of preparing such catalysts are generally complex, such processes are time consuming and expensive.

Accordingly, there is a need for an efficient and effective process of making an organic catalyst that provides the low temperature performance that industry and the consumer demands.

### SUMMARY OF THE INVENTION

The present invention relates to a process of making an organic catalyst comprising the step of reacting a substituted or unsubstituted 3,4-dihydroisoquinoline sulfur trioxide complex with a substituted or unsubstituted epoxide to form said organic catalyst, or reacting a substituted or unsubstituted 3,4-dihydroisoquinoline with a substituted or unsubstituted epoxide sulfur trioxide complex to form said organic catalyst.

The present invention also relates to organic catalysts, cleaning compositions comprising said organic catalysts, and methods of using such organic catalysts and cleaning compositions.

### DETAILED DESCRIPTION OF THE INVENTION

Definitions

As used herein, the term “cleaning composition” includes, unless otherwise indicated, granular or powder-form all-purpose or “heavy-duty” washing agents, especially laundry detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, laundry bars, mouthwashes, denture cleaners, car or carpet shampoos, bathroom cleaners; hair shampoos and hair-rinses; shower gels and foam baths and metal cleaners; as well as cleaning auxiliaries such as bleach additives and “stain-stick” or pre-treat types.

As used herein, the phrase “is independently selected from the group consisting of . . . .” means that moieties or elements that are selected from the referenced Markush group can be the same, can be different or any mixture of elements as indicated in the following example:

A molecule having 3 R groups wherein each R group is independently selected from the group consisting of A, B and C.

Here the three R groups may be: AAA, BBB, CCC, AAB, AAC, BBA, BBC, CCA, CCB, ABC. As used herein, “substituted” means that the organic composition or radical to which the term is applied is:

(a) made unsaturated by the elimination of elements or radical; or
(b) at least one hydrogen in the compound or radical is replaced with a moiety containing one or more (i) carbon, (ii) oxygen, (iii) sulfur, (iv) nitrogen or (v) halogen atoms; or
(c) both (a) and (b).
   Moieties which may replace hydrogen as described in (b) immediately above, that contain only carbon and hydrogen atoms are hydrocarbon moieties including, but not limited to, alkyl, alkenyl, alkynyl, alkyldienyl, cycloalkyl, phenyl, alkyl phenyl, naphthyl, anthryl, phenanthryl, fluoryl, steroid groups, and combinations of these groups with each other and with polyvalent hydrocarbon groups such as alkylene, alkylidene and alkylidyne groups. Moieties containing oxygen atoms that may replace hydrogen as described in (b) immediately above include, but are not limited to, hydroxy, acyl or keto, ether, epoxy, carboxy, and ester containing groups. Moieties containing sulfur atoms that may replace hydrogen as described in (b) immediately above include, but are not limited to, the sulfur-containing acids and acid ester groups, thioether groups, mercapto groups and thioketo groups. Moieties containing nitrogen atoms that may replace hydrogen as described in (b) immediately above include, but are not limited to, amino groups, the nitro group, azo groups, ammonium groups, amide groups, azido groups, isocyanate groups, cyano groups and nitrile groups. Moieties containing halogen atoms that may replace hydrogen as described in (b) immediately above include chloro, bromo, fluoro, iodo groups and any of the moieties previously described where a hydrogen or a pendant alkyl group is substituted by a halo group to form a stable substituted moiety.

It is understood that any of the above moieties (b)(i) through (b)(v) can be substituted into each other in either a monovalent substitution or by loss of hydrogen in a polyvalent substitution to form another monovalent moiety that can replace hydrogen in the organic compound or radical.

As used herein, the articles a and an when used in a claim, are understood to mean one or more of the material that is claimed or described.

Unless otherwise noted, all component or composition levels are in reference to the active level of that component or composition, and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited are, in relevant part, incorporated herein by reference; the citation of any document is not to be construed as an admission that it is prior art with respect to the present invention.

Processes of Making Organic Catalysts

Applicants disclose a process that can be used to produce a molecule that is useful, among other things, as a catalyst. Such molecule can have Formula 1 below:

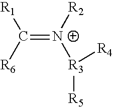

### Formula 1

wherein:

R₁ is a aryl or heteroaryl group that can be substituted or unsubstituted;
R₂ is a substituted or unsubstituted alkyl;
R₁ and R₂ when taken together with the iminium form a ring
R₃ is a C₁ to C₂₀ substituted alkyl;
R₄ is the moiety Qₜ-A
   wherein:
      Q is a branched or unbranched alkylene
      t=0 or 1 and
      A is an anionic group selected from the group consisting of OSO₃⁻, SO₃⁻, CO₂⁻, OCO₂⁻, OPO₃²⁻, OPO₃H⁻ and OPO₂⁻;
R₅ is the moiety —CR₁₁R₁₂—X—G_{b}—X_{c}—[(CR₉R₁₀)_{y}—O]ₖ—R₈
   wherein:
      each X is independently selected from the group consisting of O, S, N—H, or N—R₈; and
      each R₈ is independently selected from the group consisting of alkyl, aryl and heteroaryl, said R₈ moieties being substituted or unsubstituted, and whether substituted or unsubsituted said R₈ moieties having less than 21 carbons;
      each G is independently selected from the group consisting of CO, SO₂, SO, PO and PO₂;
      R₉ and R₁₀ are independently selected from the group consisting of H and C₁-C₄ alkyl; and
      R₁₁ and R₁₂ are independently selected from the group consisting of H and alkyl, or when taken together may join to form a carbonyl; and
      b=0 or 1;
      c can=0 or 1, but c must=0 if b=0;
      y is an integer from 1 to 6;
      k is an integer from 0 to 20; and
R₆ is H, or an alkyl, aryl or heteroaryl moiety; said moieties being substituted or unsubstituted.

In one aspect such molecule has the Formula 1 above

wherein:

R₁ is a aryl or heteroaryl group that can be substituted or unsubstituted;
R₂ is a substituted or unsubstituted alkyl;
R₁ and R₂ when taken together with the iminium form a ring;
R₃ is a C₁ to C₁₂ substituted alkyl;
R₄ is the moiety Qₜ-A
   wherein:
      Q is a C₁ to C₃ alkyl;
      t=0 or 1 and
      A is an anionic group selected from the group consisting of OSO₃⁻, SO₃⁻, CO₂⁻, and OCO₂⁻;
R₅ is the moiety —CR₁₁R₁₂—X—G_{b}—X_{c}—R₈
   wherein:
      each X is independently selected from the group consisting of
      O, S, N—H, or N—R₈; and
      each R₈ is independently selected from the group consisting of alkyl, aryl and heteroaryl, said R₈ moieties being substituted or unsubstituted, and whether substituted or unsubsituted said R₈ moieties having less than 21 carbons;
      each G is independently selected from the group consisting of CO, SO₂, SO, PO and PO₂;
      R₁₁ and R₁₂ are independently selected from the group consisting of H and alkyl;
      b=0 or 1;
      c can=0 or 1, but c must=0 if b=1; and
R₆ is H, or an alkyl, aryl or heteroaryl moiety; said moieties being substituted or unsubstituted.

In another aspect such catalyst molecule has Formula 1 above:

wherein:

R₁ is a aryl or heteroaryl group that can be substituted or unsubstituted;
R₂ is a substituted or unsubstituted alkyl;
R₁ and R₂ when taken together with the iminium form a six membered ring;
R₃ is a substituted C₂ alkyl;
R₄ is OSO₃⁻;
R₅ is the moiety —CH₂—O—R₈ wherein R₈ is independently selected from the group consisting of alkyl, aryl and heteroaryl, said R₈ moiety being substituted or unsubstituted, and whether substituted or unsubsituted said R₈ moiety having less than 21 carbons; and
R₆ is H, or an alkyl, aryl or heteroaryl moiety; said moieties being substituted or unsubstituted.

Commercial quantities of Applicants' catalyst can be produced using a variety of reaction vessels and processes including batch, semi-batch and continuous processes. The efficiency of the process disclosed herein allows an artisan to produce final reaction mixtures that contain a variety of catalyst concentrations, including but not limited to, at least 1 wt. % catalyst, at least 25 wt. % catalyst or from about 5 wt. % to about 75 wt %.

In one aspect of Applicants invention, the process of making the aforementioned catalyst comprises the step of reacting a substituted or unsubstituted 3,4-dihydroisoquinoline sulfur trioxide complex with a substituted or unsubstituted epoxide to form said organic catalyst.

In another aspect of Applicants' invention, the process of making the aforementioned catalyst comprises the steps of reacting a substituted or unsubstituted 3,4-dihydroisoquinoline with a material selected from the group consisting of sulfur trioxide, a material that provides sulfur trioxide and mixtures thereof, to form a substituted or unsubstituted 3,4-dihydroisoquinoline sulfur trioxide complex, and reacting such substituted or unsubstituted 3,4-dihydroisoquinoline sulfur trioxide complex with a substituted or unsubstituted epoxide to form said organic catalyst. Surprisingly, in the aforementioned aspects of the invention, the aromatic ring of the 3,4-dihydroisoquinoline does not appear to sulfonate to an extent that would limit the yield of catalyst.

In another aspect of Applicants' invention, the process of making the aforementioned catalyst comprises the step of reacting a substituted or unsubstituted 3,4-dihydroisoquinoline with a substituted or unsubstituted epoxide sulfur trioxide complex to form said organic catalyst.

In another aspect of Applicants' invention, the process of making the aforementioned catalyst comprises the steps of reacting a substituted or unsubstituted epoxide with a material selected from the group consisting of sulfur trioxide, a material that provides sulfur trioxide and mixtures thereof, to form a substituted or unsubstituted epoxide sulfur trioxide complex, and reacting such substituted or unsubstituted epoxide sulfur trioxide complex with a substituted or unsubstituted 3,4-dihydroisoquinoline to form said organic catalyst. Surprisingly in the two previous aspects of the invention, the timing of the addition of the 3,4-dihydroisoquinoline does not seem to adversely impact the reaction sufficiently to limit the yield of catalyst.

The oxaziridinium ring containing version of the aforementioned catalyst may be produced by contacting an iminium ring containing version of said catalyst with an oxygen transfer agent such as a peroxycarboxylic acid or a peroxymonosulfuricacid. Such species can be formed in situ and used without purification.

While the skilled artisan who processes the teachings of this specification can easily determine the desired reaction conditions and reactant concentrations, typical reaction parameters for the aforementioned aspects of Applicants' invention include reaction temperatures of from about 0° C. to about 150° C., or from about 0° C. to about 125° C., reaction pressures of from about 0.1 to about 100 atmospheres, from about 0.3 atmospheres to about 10 atmospheres or from about 1 atmosphere to about 10 atmospheres; reaction times of 0.1 hours to about 96 hours, from about 1 hour to about 72 hours, or from about 1 hour to about 24 hours. The reaction may also be run under an inert atmosphere or otherwise anhydrous conditions including, when a solvent is employed, the use of an anhydrous solvent.

Materials that are employed in practicing Applicants' process include substituted 3,4-dihydroisoquinolines, unsubstituted 3,4-dihydroisoquinolines and mixtures thereof; substituted epoxides, unsubstituted epoxides and mixtures thereof; sulfur trioxide, sources of sulfur trioxide and mixtures thereof; and solvents.

When one or more substituted 3,4-dihydroisoquinolines, unsubstituted 3,4-dihydroisoquinolines or mixtures thereof are employed, the initial reaction mixture typically comprises from about 0.5 weight % to about 70 weight %, from about 5 weight % to about 70 weight %, or from about 10 weight % to about 50 weight % of such material. Suitable substituted or unsubstituted 3,4-dihydroisoquinolines include 3,4-dihydro-6,7-dimethoxy-isoquinoline; 3,4-dihydro-3-methyl-isoquinoline; and 1-methyl-3,4 dihydroisoquinoline, all available from Acros Organics Janssens Parmaceuticalaan 3AGeel, 2440 Belgium. 1-Benzyl-3,4-dihydro-isoquinoline available from City Chemical LLC, 139 Allings Crossing Road, West Haven, Conn., 06516 USA. 3,4-dihydro-3,3-dimethyl-isoquinoline available from MicroChemistry Ltd. Shosse Entusiastov 56 Moscow, 111123 Russia. Additional 3,4-dihydroisoqunolines such as 3,4-dihydroisoquinoline; 3,4-dihydro-7-tert butyl-isoquinoline; 3,4-dihydro-4,4-dimethyl-Isoquinoline; 3,4-dihydro-4-phenyl-Isoquinoline; 4-butyl-3,4-dihydro-4-phenyl-Isoquinoline; and 3,4-dihydro-7-methyl-isoquinoline can be obtained through the synthetic routes given in Examples 1 through 6 of this specification.

When one or more substituted epoxides, unsubstituted epoxides or mixtures thereof are employed, the initial reaction mixture typically comprises from about 0.5 weight % to about 70 weight %, from about 5 weight % to about 70 weight %, or from about 10 weight % to about 50 weight % of such material. Suitable substituted or unsubstituted epoxides include but are not limited to epoxides such as 2-ethylhexyl glycidyl ether; 1,2-epoxypropane; 2,2-dimethyl-oxirane; 2-methyl-oxiranecarboxylic acid, methyl ester; (2R,3R)-diphenyl-oxirane; (2S,3S)-2-methyl-3-phenyl oxirane; and 3-ethenyl-7-oxabicyclo[4.1.0]heptane, all available from Aldrich, P.O. Box 2060, Milwaukee, Wis. 53201, USA. Additional suitable epoxides include, 1,2-Epoxydodecane; 1,2-epoxyoctane; 2-ethyl-2-methyl-oxirane; 6,6-dimethyl-spiro[bicyclo[3.1.1]heptane-2,2′-oxirane]; 3-methyl-oxiranecarboxylic acid, ethyl ester; and 3,6-Dioxabicyclo[3.1.0]hexane, all available from Acros Organics, Janssens Parmaceuticalaan, 3A Geel, 2440 Belgium; 2-Methyl-2-phenyl-Oxirane, available from TCI America, 9211 N. Harborgate Street, Portland Oreg., 97203, USA; 2,2-Diphenyl-oxirane, available from Ryan Scientific, Inc., P O Box 845, Isle of Palms S.C., 29451, USA; (2R,3S)-Dimethyl-oxirane available from Pfaltz & Bauer, Inc., 172 E. Aurora Street, Waterbury Conn., 06708, USA; and 8-Oxabicyclo[5.1.0]octane available from Advanced Synthesis Technologies, P O Box 437920, San Ysidro Calif., USA. 2-Propylheptyl glycidal ether can be prepared as described in Example 7 of this specification.

When sulfur trioxide, sources of sulfur trioxide and mixtures thereof are employed, the initial reaction mixture typically comprises from about 0.5 weight % to about 70 weight %, from about 5 weight % to about 70 weight %, or from about 10 weight % to about 50 weight % of such material. Suitable materials include sulfur trioxide, and sulfur trioxide complexes such as sulfur trioxide trimethylamine, sulfur trioxide dioxane, sulfur trioxide pyridine, sulfur trioxide N,N-dimethylformamide, sulfur trioxide sulfolane, sulfur trioxide tetrahydrofuran, sulfur trioxide diethylether, and sulfur trioxide 3,4-dyhydroisoquinoline. Suitable sulfur trioxide complexes and sulfur trioxide can be purchased from Aldrich, P.O. Box 2060, Milwaukee, Wis. 53201, USA or prepared according to the teachings of this specification.

The balance of any reaction mixture is typically solvent. When a solvent is employed, the initial reaction mixture typically comprises up to 99 weight % solvent, from about 10 weight % to about 90 weight % solvent, or from about 20 weight % to about 80 weight % solvent. Suitable solvents include aprotic, polar and apolar solvents such as acetonitile, dioxane, tertbutyl methylether, tetrahydrofuran, N,N-dimethylformamide, sulfolane, chlorobenzene, toluene, 1,2 dichloroethane, methylene chloride, chloroform, diethyl ether, hexanes, pentanes, benzene and xylenes. Suitable solvents can be purchased from Aldrich, P.O. Box 2060, Milwaukee, Wis. 53201, USA.

Cleaning Compositions and Cleaning Composition Additives Comprising Catalysts

Organic catalysts produced according to the process described herein may be advantageously employed in cleaning and/or bleaching applications for example, in laundry applications, hard surface cleaning, automatic dishwashing applications, as well as cosmetic applications such as dentures, teeth, hair and skin.

The organic catalysts of the present invention may also be employed in a cleaning additive product. A cleaning additive product including the organic catalysts of the present invention is ideally suited for inclusion in a wash process when additional bleaching effectiveness is desired. Such instances may include, but are not limited to, low temperature solution cleaning application. The additive product may be, in its simplest form, the organic catalyst. Preferably, the additive could be packaged in dosage form for addition to a cleaning process where a source of peroxygen is employed and increased bleaching effectiveness is desired. Such single dosage form may comprise a pill, tablet, gelcap or other single dosage unit such as pre-measured powders or liquids. A filler or carrier material may be included to increase the volume of such composition. Suitable filler or carrier materials include, but are not limited to, various salts of sulfate, carbonate and silicate as well as talc, clay and the like. Filler or carrier materials for liquid compositions may be water or low molecular weight primary and secondary alcohols including polyols and diols. Examples of such alcohols include, but are not limited to, methanol, ethanol, propanol and isopropanol. The compositions may contain from about 5% to about 90% of such materials. Acidic fillers can be used to reduce pH. Alternatively, the cleaning additive may include activated peroxygen source defined below or the adjunct ingredients as fully defined below.

Cleaning compositions and cleaning additives require a catalytically effective amount of organic catalyst. The required level of such catalyst may be achieved by the addition of one or more species of the organic catalyst produced according to the process disclosed herein. As a practical matter, and not by way of limitation, the compositions and cleaning processes herein can be adjusted to provide on the order of at least 0.001 ppm of organic catalyst in the washing medium, and will preferably provide from about 0.001 ppm to about 500 ppm, more preferably from about 0.005 ppm to about 150 ppm, and most preferably from about 0.05 ppm to about 50 ppm, of the organic catalyst in the wash liquor. In order to obtain such levels in the wash liquor, typical compositions herein will comprise from about 0.0002% to about 5%, more preferably from about 0.001% to about 1.5%, of organic catalyst, by weight of the cleaning compositions.

When said organic catalyst is employed in a granular composition, it may be desirable for the organic catalyst to be in the form of an encapsulated particle that protects the organic catalyst from moisture and/or other components of the granular composition during storage. In addition, encapsulation is also a means of controlling the availability of the organic catalyst during the cleaning process and may enhance the bleaching performance of the organic catalyst. In this regard, the organic catalyst can be encapsulated with any encapsulating material known in the art.

The encapsulating material typically encapsulates at least part, preferably all, of the Applicants' organic catalyst. Typically, the encapsulating material is water-soluble and/or water-dispersible. The encapsulating material may have a glass transition temperature (Tg) of 0° C. or higher. Glass transition temperature is described in more detail in WO 97/11151, especially from page 6, line 25 to page 7, line 2. As such, WO 97/11151 is incorporated herein by reference.

In addition to said organic catalysts, cleaning compositions must comprise an activated peroxygen source. Suitable ratios of moles of organic catalyst to moles of activated peroxygen source include but are not limited to from about 1:1 to about 1:1000. Suitable activated peroxygen sources include, but are not limited to, preformed peracids, a hydrogen peroxide source in combination with a bleach activator, or a mixture thereof. Suitable preformed peracids include, but are not limited to, compounds selected from the group consisting of percarboxylic acids and salts, percarbonic acids and salts, perimidic acids and salts, peroxymonosulfuric acids and salts, and mixtures thereof. Suitable sources of hydrogen peroxide include, but are not limited to, compounds selected from the group consisting of perborate compounds, percarbonate compounds, perphosphate compounds and mixtures thereof.

Suitable bleach activators include, but are not limited to, tetraacetyl ethylene diamine (TAED), benzoylcaprolactam (BzCL), 4-nitrobenzoylcaprolactam, 3-chlorobenzoylcaprolactam, benzoyloxybenzenesulphonate (BOBS), nonanoyloxybenzenesulphonate (NOBS), phenyl benzoate (PhBz), decanoyloxybenzenesulphonate (C₁₀-OBS), benzoylvalerolactam (BZVL), octanoyloxybenzenesulphonate (C₈-OBS), perhydrolyzable esters, perhydrolyzable imides and mixtures thereof

When present, hydrogen peroxide sources will typically be at levels of from about 1%, preferably from about 5% to about 30%, preferably to about 20% by weight of the composition. If present, peracids or bleach activators will typically comprise from about 0.1%, preferably from about 0.5% to about 60%, more preferably from about 0.5% to about 40% by weight of the bleaching composition.

In addition to the disclosure above, suitable types and levels of activated peroxygen sources are found in U.S. Pat. Nos. 5,576,282, 6,306,812 B1 and 6,326,348 B1 that are incorporated by reference.

The cleaning compositions herein will preferably be formulated such that, during use in aqueous cleaning operations, the wash water will have a pH of between about 6.5 and about 11, preferably between about 7.5 and 10.5. Liquid dishwashing product formulations preferably have a pH between about 6.8 and about 9.0. Laundry products are typically at pH 9-11. Techniques for controlling pH at recommended usage levels include the use of buffers, alkalis, acids, etc., and are well known to those skilled in the art.

Adjunct Materials

While not essential for the purposes of the present invention, the non-limiting list of adjuncts illustrated hereinafter are suitable for use in the instant cleaning compositions and may be desirably incorporated in preferred embodiments of the invention, for example to assist or enhance cleaning performance, for treatment of the substrate to be cleaned, or to modify the aesthetics of the cleaning composition as is the case with perfumes, colorants, dyes or the like. The precise nature of these additional components, and levels of incorporation thereof, will depend on the physical form of the composition and the nature of the cleaning operation for which it is to be used. Suitable adjunct materials include, but are not limited to, surfactants, builders, chelating agents, dye transfer inhibiting agents, dispersants, enzymes, and enzyme stabilizers, catalytic metal complexes, polymeric dispersing agents, clay soil removal/anti-redeposition agents, brighteners, suds suppressors, dyes, perfumes, structure elasticizing agents, fabric softeners, carriers, hydrotropes, processing aids and/or pigments. In addition to the disclosure below, suitable examples of such other adjuncts and levels of use are found in U.S. Pat. Nos. 5,576,282, 6,306,812 B1 and 6,326,348 B1 that are incorporated by reference.

Surfactants—Preferably, the cleaning compositions according to the present invention comprise a surfactant or surfactant system wherein the surfactant can be selected from nonionic and/or anionic and/or cationic surfactants and/or ampholytic and/or zwitterionic and/or semi-polar nonionic surfactants.

The surfactant is typically present at a level of from about 0.1%, preferably about 1%, more preferably about 5% by weight of the cleaning compositions to about 99.9%, preferably about 80%, more preferably about 35%, most preferably about 30% by weight of the cleaning compositions.

Builders—The cleaning compositions of the present invention preferably comprise one or more detergent builders or builder systems. When present, the compositions will typically comprise at least about 1% builder, preferably from about 5%, more preferably from about 10% to about 80%, preferably to about 50%, more preferably to about 30% by weight, of detergent builder.

Builders include, but are not limited to, the alkali metal, ammonium and alkanolammonium salts of polyphosphates, alkali metal silicates, alkaline earth and alkali metal carbonates, aluminosilicate builders polycarboxylate compounds. ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Chelating Agents—The cleaning compositions herein may also optionally contain one or more copper, iron and/or manganese chelating agents.

If utilized, these chelating agents will generally comprise from about 0.1% by weight of the cleaning compositions herein to about 15%, more preferably 3.0% by weight of the cleaning compositions herein.

Dye Transfer Inhibiting Agents—The cleaning compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof.

When present in the cleaning compositions herein, the dye transfer inhibiting agents are present at levels from about 0.0001%, more preferably about 0.01%, most preferably about 0.05% by weight of the cleaning compositions to about 10%, more preferably about 2%, most preferably about 1% by weight of the cleaning compositions.

Dispersants—The cleaning compositions of the present invention can also contain dispersants. Suitable water-soluble organic materials are the homo- or co-polymeric acids or their salts, in which the polycarboxylic acid comprises at least two carboxyl radicals separated from each other by not more than two carbon atoms.

Enzymes—The cleaning compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and known amylases, or mixtures thereof. A preferred combination is a cleaning composition having a cocktail of conventional applicable enzymes like protease, lipase, cutinase and/or cellulase in conjunction with amylase.

Enzyme Stabilizers—Enzymes for use in detergents can be stabilized by various techniques. The enzymes employed herein can be stabilized by the presence of water-soluble sources of calcium and/or magnesium ions in the finished compositions that provide such ions to the enzymes.

Catalytic Metal Complexes—Applicants' cleaning compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra (methylenephosphonic acid) and water-soluble salts thereof. Such catalysts are disclosed in U.S. Pat. No. 4,430,243 Bragg, issued Feb. 2, 1982.

If desired, the compositions herein can be catalyzed by means of a manganese compound. Such compounds and levels of use are well known in the art and include, for example, the manganese-based catalysts disclosed in U.S. Pat. No. 5,576,282 Miracle et al.

Cobalt bleach catalysts useful herein are known, and are described, for example, in U.S. Pat. No. 5,597,936 Perkins et al., issued Jan. 28, 1997; U.S. Pat. No. 5,595,967 Miracle et al., Jan. 21, 1997. Such cobalt catalysts are readily prepared by known procedures, such as taught for example in U.S. Pat. No. 5,597,936, and U.S. Pat. No. 5,595,967.

Compositions herein may also suitably include a transition metal complex of a macropolycyclic rigid ligand-abreviated as “MRL”. As a practical matter, and not by way of limitation, the compositions and cleaning processes herein can be adjusted to provide on the order of at least one part per hundred million of the active MRL species in the aqueous washing medium, and will preferably provide from about 0.005 ppm to about 25 ppm, more preferably from about 0.05 ppm to about 10 ppm, and most preferably from about 0.1 ppm to about 5 ppm, of the MRL in the wash liquor.

Preferred transition-metals in the instant transition-metal bleach catalyst include manganese, iron and chromium. Preferred MRL's herein are a special type of ultra-rigid ligand that is cross-bridged such as 5,12-diethyl-1,5,8,12-tetraazabicyclo[6.6.2]hexadecane.

Suitable transition metal MRLs are readily prepared by known procedures, such as taught for example in WO 00/332601, and U.S. Pat. No. 6,225,464.

Processes of Making and Using of Applicants' Cleaning Composition

The cleaning compositions of the present invention can be formulated into any suitable form and prepared by any process chosen by the formulator, non-limiting examples of which are described in U.S. Pat. No. 5,879,584 Bianchetti et al., issued Mar. 9, 1999; U.S. Pat. No. 5,691,297 Nassano et al., issued Nov. 11, 1997; U.S. Pat. No. 5,574,005 Welch et al., issued Nov. 12, 1996; U.S. Pat. No. 5,569,645 Dinniwell et al., issued Oct. 29, 1996; U.S. Pat. No. 5,565,422 Del Greco et al., issued Oct. 15, 1996; U.S. Pat. No. 5,516,448 Capeci et al., issued May 14, 1996; U.S. Pat. No. 5,489,392 Capeci et al., issued Feb. 6, 1996; U.S. Pat. No. 5,486,303 Capeci et al., issued Jan. 23, 1996 all of which are incorporated herein by reference.

Method of Use

The cleaning and/or bleaching compositions employing said organic catalyst can be used to bleach and/or clean a situs inter alia a surface or fabric. Such method includes the steps of contacting an embodiment of Applicants' cleaning composition, in neat form or diluted in a wash liquor, with at least a portion of a surface or fabric then rinsing such surface or fabric. Preferably the surface or fabric is subjected to a washing step prior to the aforementioned rinsing step. For purposes of the present invention, washing includes but is not limited to, scrubbing, and mechanical agitation. As will be appreciated by one skilled in the art, the cleaning and/or bleaching compositions of the present invention are ideally suited for use in laundry applications wherein a fabric is contacted with a cleaning laundry solution comprising at least one embodiment of Applicants cleaning composition, cleaning additive or mixture thereof. The fabric may comprise most any fabric capable of being laundered in normal consumer use conditions. The solution preferably has a pH of from about 8 to about 10.5. The compositions are preferably employed at concentrations of from about 500 ppm to about 15,000 ppm in solution. The water temperatures preferably range from about 5° C. to about 90° C. The water to fabric ratio is preferably from about 1:1 to about 30:1.

### EXAMPLES

Synthesis routes for Examples 1-16 are depicted herein. In such routes all structures are general structures and the moieties R₁, R₂, R₃, R_{3′}, R₄R_{4′}, R₅, R₆, R₇ and R₈ may be any suitable organic or inorganic moiety. While the synthetic pathways detailed herein employ specific synthetic transformations, as will be appreciated by one skilled in the art, other suitable synthetic transformations may be employed. 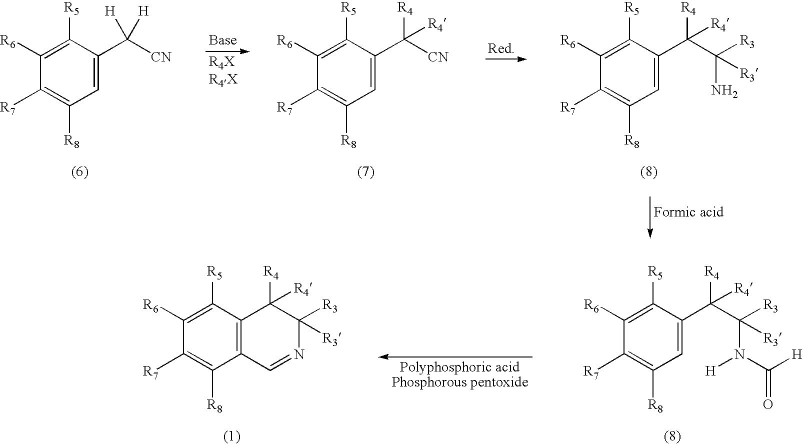
3,4-dihydroisoquinoline (1) may be obtained from benzyl nitrile (6) or (7), phenethylamine (8) and formamide (9) using the synthetic pathways detailed above. As will be appreciated by the artisan, the moieties R₃, R_{3′}, R₄ R_{4′}, R₅, R₆, R₇ and R₈ may be any suitable organic or inorganic moiety.

Raw materials required for the aforementioned syntheses are generally commercially available. The following materials can be obtained from Aldrich, P.O. Box 2060, Milwaukee, Wis. 53201, USA: Benzylnitrile, diphenylacetonitrile, 2-phenethylhexanenitrile, 4-tertbutyl benzylcyanide, 2-phenethylamine, 2-(p-tolyl)ethylamine, borane THF complex, methyl bromide, acetonitrile, toluene, hexanes, tetrahydrofuran, potassium carbonate, potassium tert-butoxide, stannic chloride, formic acid, polyphosphoric acid, epichlorohydrin, and sodium hydroxide.

### Example 1

Preparation of 3,4-dihydroisoquinoline (1, R₁, R₃, R_{3′}, R₄, R_{4′}, R₅, R₆, R₇, R₈=H)

To a flame dried 1000 ml three neck round bottomed flask, equipped with an addition funnel, dry argon inlet, magnetic stir bar, thermometer, Dean Stark trap, and heating bath is added 2-phenethylamine (8, R₃, R_{3′}, R₄, R_{4′}, R₅, R₆, R₇, R₈=H) (121 gm., 1.0 mol) and toluene (250 ml). To the addition funnel is added formic acid (46 gm., 1 mol). The formic acid is added slowly to the stirring reaction solution over 60 minutes and solids form. Once addition is complete the reaction is brought to reflux and water removed via a Dean Stark trap. Once the reaction is complete, the toluene is removed and the product (9, R₁, R₃, R_{3′}, R₄, R_{4′}, R₅, R₆, R₇, R₈=H) is purified by vacuum distillation. Formamide (9, R₁, R₃, R_{3′}, R₄, R_{4′}, R₅, R₆, R₇, R₈=H) is then contacted with polyphosphoric acid (747 gm)/phosphorous pentoxide (150 gm), using standard Bischler/Napieralski conditions, at 170° C. for 18 hours. The reaction is then neutralized with aqueous NaOH, keeping the temperature between 60°-80° C. Once neutral, the product is extracted with toluene to yield 3,4-dihydroisoquinoline (1, R₁, R₃, R_{3′}, R₄, R_{4′}, R₅, R₆, R₇, R₈=H) in 95% yield. Product can be further purified via distillation.

### Example 2

Preparation of 3,4-dihydro-7-methyl-isoquinoline (1, R₁, R₃, R_{3′}, R₄, R_{4′}, R₅, R₆, R₈=H; R₇=CH₃)

Reaction is carried out as Example 1, except 2-(p-tolyl)ethylamine is substituted for 2-phenethylamine.

### Example 3

Preparation of 3,4-dihydro-4,4-dimethyl-Isoquinoline (1, R₁, R₃, R_{3′}, R₅, R₆, R₇, R₈=H; R₄, R_{4′}=CH₃)

To a flame dried 1000 ml three neck round bottomed flask, equipped with a dry argon inlet, magnetic stir bar, and thermometer, is added benzyl cyanide (6) (117 gm., 1.0 mol) and tetrahydrofuran (500 ml). To the reaction is slowly added potassium carbonate (2 mol) over one hour. Once addition is complete the reaction is stirred at room temperature for 1 hour. To the reaction is added methyl bromide (2 mol) and the reaction is stirred at room temperature for 18 hours. The reaction is evaporated to dryness, residue dissolved in toluene and washed with 1N HCl. Organic phase is dried with Na₂SO₄, filtered and evaporated to yield crude nitrile (7, R₅, R₆, R₇, R₈=H; R₄, R_{4′}=CH₃). Crude nitrile is reduced using borane-THF complex (1 equiv.) at room temperature for 18 hours. Once reaction is complete ethanol (50 ml) is added, and the reaction is evaporated to dryness. Once dry, the residue is suspended in 100 mls 1M HCl, and the suspension is evaporated to dryness on a rotory evaporator. This procedure is repeated 3×. After the final evaporation, the white residue is dissolved in 1M NaOH (100 ml), and extracted with toluene (2×150 ml). The extracts are combined, dried with Na₂SO₄, filtered and evaporated too dryness to yield the crude amine (8, R₃, R_{3′}, R₅, R₆, R₇, R₈=H; R₄, R_{4′}=CH₃), which is converted to 3,4-dihydro4,4-dimethyl-Isoquinoline (1, R₁, R₃, R_{3′}, R₅, R₆, R₇, R₈=H; R₄, R_{4′}=CH₃) using conditions described in Example 1.

### Example 4

Preparation of 3,4-dihydro-7-tert butyl-Isoquinoline (1, R₁, R₃, R_{3′}, R₄, R_{4′}, R₅, R₆, R₈=H; R₇=C(CH₃)₃)

4-tert-Butyl benzylcyanide (7, R₄, R_{4′}, R₅, R₆, R₈=H; R₇=C(CH₃)₃) is reduced using borane-THF complex (1 equiv.) at room temperature for 18 hours. Once reaction is complete ethanol (50 ml) is added, and the reaction is evaporated to dryness. Once dry, the residue is suspended in 100 mls 1M HCl, and the suspension is evaporated to dryness on a rotory evaporator. This procedure is repeated 3×. After the final evaporation, the white residue is dissolved in 1M NaOH (100 ml), and extracted with toluene (2×150 ml). The extracts are combined, dried with Na₂SO₄, filtered and evaporated too dryness to yield the crude amine (8, R₃, R_{3′}, R₅, R₆, R₇, R₈=H; R₄, R_{4′}=C(CH₃)₃), which is converted to 3,4-dihydro-4,4-dimethyl-Isoquinoline (1, R₁, R₃, R_{3′}, R₅, R₆, R₇, R₈=H; R₄, R_{4′}=CH₃) using conditions described in Example 1.

### Example 5

Preparation of 3,4-dihydro-4-n butyl-Isoquinoline (1, R₁, R₃, R_{3′}, R₄, R₅, R₆, R₇, R₈=H; R_{4′}=(CH₂)₃CH₃)

Reaction is carried out as Example 4, except 2-phenethyl hexanenitrile (7, R₄, R₅, R₆, R₇, R₈=H; R_{4′}=(CH₂)₃CH₃) is substituted for 4-tert-butyl benzylcyanide.

### Example 6

Preparation of 3,4-dihydro-4-phenyl-Isoquinoline (1, R₁, R₃, R_{3′}, R₄, R₅, R₆, R₇, R₈=H; R_{4′}=CH₆H₆)

Reaction is carried out as Example 4, except diphenyl acetonitrile (7, R₄, R₅, R₆, R₇, R₈=H; R_{4′}=C₆H₆) is substituted for 4-tert-butyl benzylcyanide.

### Example 7

Preparation of 2-propyl heptyl glycidal ether

To a flame dried, 500 ml round bottomed flask equipped with an addition funnel charged with epichlorohydrin (15.62 gm., 0.17 moles), is added 2-propylheptanol (Pfaltz & Bauer, Inc., 172 E. Aurora Street, Waterbury Conn., 06708, USA) (20 gm., 0.127 moles) and stannic chloride (0.20 gm., 0.001 moles). The reaction is kept under an argon gas atmosphere and warmed to 90° C. using an oil bath. Epichlorohydrin is dripped into the stirring solution over 60 minutes followed by stirring at 90° C. for 18 hours. The reaction is fitted with a vacuum distillation head and 1-chloro-3-(2-propyl-heptyloxy)-propan-2-ol is distilled at a temperature range of 90° C.->95° C. under 0.2 mm Hg. Wt.=22.1 gm. The 1-chloro-3-(2-propyl-heptyloxy)-propan-2-ol (5.0 gm., 0.020 moles) is dissolved in tetrahydrofuran (50 mL) and stirred at RT under an argon atmosphere. To the stirring solution is added potassium tert-butoxide (2.52 gm., 0.022 moles) and the suspension is stirred at RT for 18 hours. The reaction is then evaporated to dryness, residue dissolved in hexanes and washed with water (100 ml). The hexanes phase is separated, dried with Na₂SO₄, filtered and evaporated to dryness to yield the crude 2-propyl heptyl glycidal ether, which can be further purified by vacuum distillation.

Synthesis routes for Examples 8-16 are depicted below. 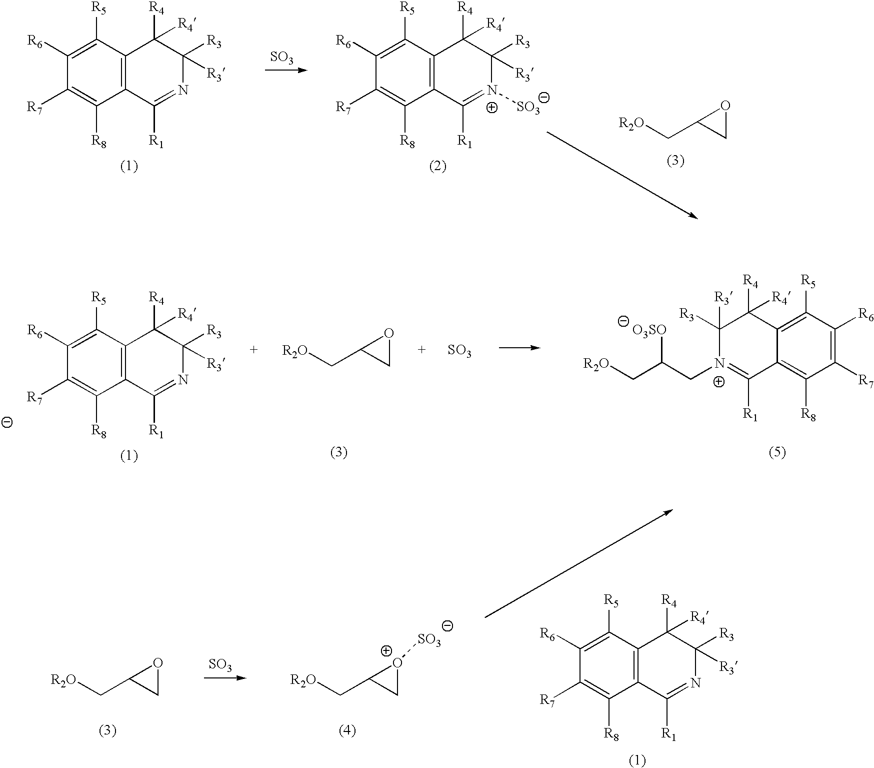
3,4-dihydroisoquinoline (1) may be converted to its sulfur trioxide 3,4-dihydroisoquinoline complex (2) via contacting 3,4-dihydroisoquinoline (1) with a source of SO₃, followed by contacting the sulfur trioxide 3,4-dihydroisoquinoline complex (2) with an appropriate glycidal ether (3) to give organic catalyst (5). Similarly an appropriate glycidal ether (3) may be converted to its sulfur trioxide glycidal ether complex (4) via contacting the appropriate glycidal ether (3) with a source of SO₃, followed by contacting the sulfur trioxide glycidal ether complex (4) with 3,4-dihydroisoquinoline (1) to give organic catalyst (5). Organic catalyst (5) may also be prepared by contacting simultaneously 3,4-dihydroisoquinoline (1), glycidal ether (3), and a source of sulfur trioxide in a single operation.

Raw materials required for the aforementioned syntheses are generally commercially available. The following materials can be obtained from Aldrich, P.O. Box 2060, Milwaukee, Wis. 53201, USA: acetonitrile, tetrahydrofuran, methylene chloride, diethyl ether, chlorobenzene, sulfur trioxide, sulfur trioxide-trimethylamine complex, sulfur trioxide-N,N-dimethylformamide complex, ethyl acetate, isopropanol, 2-ethylhexyl glycidal ether, glycidyl 4-nonylphenyl ether, glycidyl 2,2,3,3,4,4,5,5,6,6,7,7-dodecafluoroheptyl ether. 6,7-Dimethoxy-3,4-dihydroisoquinoline hydrochloride hydrate can be purchased form Fisher Scientific 1 Reagent Lane Fair Lawn, N.J., 07410 USA. Glycidal ethers such as (2-ethylhexyloxy)oxiran-2-ylmethane can be acquired through the Raschig Corporation, 129 South Scoville Avenue, Oak Park Ill., 60302, U.S.A, under the product name EHGE.

### Example 8

Preparation of Sulfuric acid mono-[2-(3,4-dihydro-isoquinolin-2-yl)-1-(2-ethyl-hexyloxymethyl)-ethyl]ester, internal salt via synthesis route (1) to (2) to (5)

To a flame dried 250 ml three neck round bottomed flask, equipped with an addition funnel, dry argon inlet, magnetic stir bar, thermometer, and cooling bath is added 3,4-dihydroisoquinoline (1) (5.0 gm, 0.038 mol.) and acetonitrile (50 ml). To the addition funnel is added methylene chloride (10 ml) and neat sulfuric anhydride (SO₃) (3.05 gm, 0.038 mol). The reaction vessel is placed in an ice bath and contents cooled to 5° C. To the reaction solution is added dropwise the SO₃/CH₂Cl₂ solution over 30 minutes keeping the temperature below 10° C. A white precipitate (2) forms upon addition of the sulfuric anhydride. Once addition is complete the reaction is allowed to warm to room temperature and the white suspension stirred for 1 hour under argon. To the reaction is added 2-ethylhexyl glycidal ether (3) (7.1 gm, 0.038 mol) and the reaction is placed in a 90° C. oil bath. The methylene chloride is removed via Dean Stark Trap and once removed an internal reaction temperature of 75-80° C. is obtained, upon which the reaction turns clear/amber. The reaction is stirred at 75-80° C. for 72 hours. The reaction is then cooled to room temperature, evaporated to dryness and the tan residue recrystallized from isopropanol, to yield the desired product (5, R₁, R₃, R₄, R₅, R₆, R₇, R₈=H; R₂=2-ethylhexyl), 10.3 gm (68%), 19 wt. % of the final reaction mixture.

### Example 9

Preparation of Sulfuric acid mono-[2-(3,4-dihydro-isoquinolin-2-yl)-1-(2-ethyl-hexyloxymethyl)-ethyl]ester, internal salt

To a flame dried 250 ml three neck round bottomed flask, equipped with a condenser, dry argon inlet, magnetic stir bar, thermometer, and heating bath is added 3,4-dihydroisoquinoline (1) (50.0 gm, 0.38 mol.), 2-ethylhexyl glycidal ether (3) (71 gm, 0.38 mol) SO₃-DMF complex (58.2 gm, 0.38 mol), and acetonitrile (500 ml). The reaction is warmed to 80° C. and stirred at temperature for 72 hours. The reaction is cooled to room temperature, evaporated to dryness and the residue recrystallized from ethyl acetate/ethanol to yield the desired product (5, R₁, R₃, R₄, R₅, R₆, R₇, R₈=H; R₂=2-ethylhexyl) 105 gm (55%), 18 wt. % of the final reaction mixture.

### Example 10

Preparation of Sulfuric acid mono-[2-(3,4-dihydro-isoquinolin-2-yl)-1-(2,2,3,3,4,4,5,5,6,6,7,7-dodecafluroheptyloxymethyl)-ethyl]ester, internal salt

To a flame dried 250 ml three neck round bottomed flask, equipped with an addition funnel, dry argon inlet, magnetic stir bar, thermometer, and cooling bath is added glycidyl 2,2,3,3,4,4,5,5,6,6,7,7-dodecafluoroheptyl ether (3) (12.8 gm, 0.038 mol) and acetonitrile (50 ml). To the addition funnel is added methylene chloride (10 ml) and neat sulfuric anhydride (SO₃) (3.05 gm, 0.038 mol). The reaction vessel is placed in an ice/methanol bath and the contents cooled to −15° C. To the reaction solution is added dropwise the SO₃/CH₂Cl₂ solution over 30 minutes keeping the temperature below −10° C. Once addition is complete to the reaction is added 3,4-dihydroisoquinoline (1) (5.0 gm, 0.038 mol.) and the reaction is allowed to warm to RT. The reaction is stirred at room temperature for I hour and then placed in a 90° C. oil bath. The methylene chloride is removed via Dean Stark Trap and once removed an internal reaction temperature of 75-80° C. is obtained. The reaction is stirred at 75-80° C. for 72 hours. The reaction is then cooled to room temperature, evaporated to dryness and the residue recrystallized from an appropriate solvent to yield the desired product (5, R₁, R₃, R₄, R₅, R₆, R₇, R₈=H, R₂=2,2,3,3,4,4,5,5,6,6,7,7-dodecafluroheptyl)

### Example 11

Preparation of Sulfuric acid mono-[2-(3,4-dihydro-isoquinolin-2-yl)-1-(4-nonylphenyloxymethyl)-ethyl]ester, internal salt

To a flame dried 250 ml one neck round bottomed flask, equipped with condenser, dry argon inlet, magnetic stir bar, and heating bath is added 3,4-dihydroisoquinoline (1) (5.0 gm, 0.038 mol.), hexanes (100 ml), and sulfur trioxide trimethyl amine complex. The reaction is brought to reflux and trimethylamine is driven off through the condenser, which is monitored with pH paper. Once the reaction vapor is neutral the reaction is cooled to room temperature and the white solids (2) filtered off and dried under high vacuum. Once dry, the solids (2) are placed in a flame dried 250 ml round bottomed flask equipped with an argon inlet, condenser, magnetic stir bar, and heating bath, and suspended in acetonitrile (50 ml). To the suspension is added glycidyl 4-nonylphenyl ether (3) (10.5 gm, 0.038 mol) and the reaction is brought to reflux. Reaction is stirred at reflux for 72 hours. The reaction is cooled to room temperature, evaporated to dryness, and the residue recrystallized from an appropriate solvent to yield the desired product (5, R₁, R₃, R₄, R₅, R₆, R₇, R₈=H, R₂=4-nonylphenyl)

### Example 12

Preparation of Sulfuric acid mono-[2-(6,7-dimethoxy-3,4-dihydro-isoquinolin-2-yl)-1-(2-ethyl-hexyloxymethyl)-ethyl]ester, internal salt

Reaction is carried out as Example 11, except chlorobenzene is substituted for hexanes and 6,7-dimethoxy-3,4-dihydroisoquinoline is substituted for 3,4-dihydroisoquinoline to yield the desired product (5, R₁, R₃, R₄, R₅, R₈=H, R₂=2-ethylhexyl, R₆, R₇=OCH₃)

### Example 13

Preparation of Commercial Quantities of Catalyst in a Stirred Tank Reactor

A glycidal ether is contacted with a source of SO₃, either neat or with an appropriate aprotic solvent, for less than about 240 minutes, at a temperature of from about 0° C. to about 80° C., and a pressure of about 1 atmosphere followed by addition of a 3,4-dihydroisoquinoline and contacting the resulting reaction mixture for less than about 96 hours, at a temperature of from about 50° C. to about 150° C., and a pressure of about 1 atmosphere. Such process is conducted in a stirred tank reactor and results in the formation of an organic catalyst.

### Example 14

Preparation of Commercial Quantities of Catalyst in a Stirred Tank Reactor

A 3,4-dihydroisoquinoline is contacted with a source of SO₃, either neat or with an appropriate aprotic solvent, for less than about 240 minutes, at a temperature of from about 0° C. to about 80° C., and a pressure of about 1 atmosphere followed by addition of a glycidal ether and contacting the resulting reaction mixture for less than about 96 hours, at a temperature of from about 50° C. to about 150° C., and a pressure of about 1 atmosphere. Such process is conducted in a stirred tank reactor and results in the formation of organic catalyst.

### Example 15

Preparation of Commercial Quantities of Catalyst in a Stirred Tank Reactor

A 3,4-dihydroisoquinoline, a source of SO₃, and a glycidal ether, either neat or with an appropriate aprotic solvent, for less than about 96 hours, at a temperature of from about 50° C. to about 150° C., and a pressure of about 1 atmosphere. Such process is conducted in a stirred tank reactor and results in the formation of organic catalyst.

### Example 16

Method of Preparing a Particle Comprising the Applicants' Organic Catalyst

10 g of the Applicants' organic catalyst according to any of Examples 8-12 above is mixed thoroughly with 80 gm of sodium sulfate, 10 gm of sodium lauryl sulfonate, and 10 gm of water at 70°-90° C., to form a paste. The paste is allowed to dry to a brittle solid, and the solid is ground into a fine powder, thereby producing the desired carrier particulates.

### Example 17

Method of Preparing a Granular Detergent Comprising the Applicants' Organic Catalyst

Granular detergents comprising 0.002% to 5% of Applicants' organic catalyst, are made by dusting fine particulates (particulates having a mean particle size of less than about 100 um) comprising Applicants' catalyst on to a detergent mix during the detergent making process, and/or by combining a carrier particle comprising Applicants' catalyst with said detergent mix during the detergent making process. Such finished detergents are found to contain a uniform distribution of Applicants' organic catalyst wherein the relative standard deviation is less than 20% per 30 gram sample.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A process of making an organic catalyst comprising the step of reacting a substituted 3,4-dihydroisoquinoline sulfur trioxide complex, an unsubstituted 3,4-dihydroisoquinoline sulfur trioxide complex and mixtures thereof with a substituted epoxide, an unsubstituted epoxide and mixtures thereof, to form said organic catalyst.

2. The process of claim 1 wherein said reaction step is conducted in the presence of an aprotic solvent.

3. The process of claim 1 wherein said reaction step is conducted at a temperature from about 0° C. to about 150° C.

4. The process of claim 1 wherein the final reaction mixture comprises at least 5 weight percent organic catalyst.

5. The process of claim 2 wherein:
a.) said reaction step is conducted at a temperature from about 0° C. to about 150° C.;
b.) said reaction step is conducted at a pressure of from about 0.1 atmospheres to about 100 atmospheres; and
c.) said aprotic solvent comprises a polar aprotic solvent.

6. The process of claim 1 comprising the step of reacting a substituted 3,4-dihydroisoquinoline, an unsubstituted 3,4-dihydroisoquinoline and mixtures thereof with a material selected from the group consisting of sulfur trioxide, a material that provides sulfur trioxide and mixtures thereof, to form a substituted 3,4-dihydroisoquinoline sulfur trioxide complex, an unsubstituted 3,4-dihydroisoquinoline sulfur trioxide complex and mixtures thereof.

7. The process of claim 6 wherein said reaction step is conducted in the presence of an aprotic solvent.

8. The process of claim 6 wherein said reaction step is conducted at a temperature from about 0° C. to about 150° C.

9. The process of claim 6 wherein the final reaction mixture comprises at least 5 weight percent organic catalyst.

10. The process of claim 7 wherein:
a.) said reaction step is conducted at a temperature from about 0° C. to about 150° C.;
b.) said reaction step is conducted at a pressure of from about 0.1 atmospheres to about 100 atmospheres; and
c.) said aprotic solvent comprises a polar aprotic solvent.

11. A process of making an organic catalyst comprising the step of reacting a substituted 3,4-dihydroisoquinoline, an unsubstituted 3,4-dihydroisoquinoline and mixtures thereof, with a substituted epoxide sulfur trioxide complex, an unsubstituted epoxide sulfur trioxide complex and mixtures thereof, to form said organic catalyst.

12. The process of claim 11 wherein said reaction step is conducted in the presence of an aprotic solvent.

13. The process of claim 11 wherein said reaction step is conducted at a temperature from about 0° C. to about 150° C.

14. The process of claim 11 wherein the final reaction mixture comprises at least 5 weight percent organic catalyst.

15. The process of claim 12 wherein:
a.) said reaction step is conducted at a temperature from about 0° C. to about 150° C.;
b.) said reaction step is conducted at a pressure of from about 0.1 atmospheres to about 100 atmospheres; and
c.) said aprotic solvent comprises a polar aprotic solvent.

16. The process of claim 11 comprising the step of reacting a substituted epoxide, an unsubstituted epoxide and mixtures thereof with a material selected from the group consisting of sulfur trioxide, a material that provides sulfur trioxide and mixtures thereof, to form a substituted epoxide sulfur trioxide complex, an unsubstituted epoxide sulfur trioxide complex and mixtures thereof.

17. The process of claim 16 wherein said reaction step is conducted in the presence of an aprotic solvent.

18. The process of claim 16 wherein the final reaction mixture comprises at least 5 weight percent organic catalyst.

19. The process of claim 17 wherein:
a.) said reaction step is conducted at a temperature from about 0° C. to about 150° C.;
b.) said reaction step is conducted at a pressure of from about 0.1 atmospheres to about 100 atmospheres; and
c.) said aprotic solvent comprises a polar aprotic solvent.

20. A process of making an organic catalyst comprising the step of reacting a substituted 3,4-dihydroisoquinoline, an unsubstituted 3,4-dihydroisoquinoline and mixtures thereof, a substituted epoxide, an unsubstituted epoxide and mixtures thereof, and a material selected from the group consisting of sulfur trioxide, a material that provides sulfur trioxide and mixtures thereof, to form said organic catalyst.
